(19) United States
(12) Patent Application Publication
(10) Pub. No.: US 2014/0313218 A1
(43) Pub. Date: Oct. 23, 2014

(54) METHOD AND APPARATUS FOR CONTROLLING TRANSPARENCY IN PORTABLE TERMINAL HAVING TRANSPARENT DISPLAY UNIT

(71) Applicant: Samsung Electronics Co., Ltd., Gyeonggi-do (KR)

(72) Inventors: Yujin LEE, Seoul (KR); Huncheol OH, Seoul (KR); Dongho JANG, Gyeonggi-do (KR); Boseul JEON, Gyeonggi-do (KR)

(73) Assignee: Samsung Electronics Co., Ltd., Gyeonggi-do (KR)

(21) Appl. No.: 14/254,221

(22) Filed: Apr. 16, 2014

(30) Foreign Application Priority Data
Apr. 17, 2013 (KR) 10-2013-0042161

(51) Int. Cl. G09G 5/10

(52) U.S. Cl. CPC G09G 5/10
USPC 345/589

(57) ABSTRACT

A method and an apparatus for controlling a transparency of a portable terminal, including a transparent display unit configured to display an application and a controller configured to: receive an event information to execute the application, determine a display mode of the application based on the received event information, and control the transparent display unit to adjust a transparency of the transparent display unit according to the determined display mode.

### CROSS REFERENCE TO RELATED APPLICATION

This application claims the benefit under 35 U.S.C. §119(a) of a Korean patent application filed on Apr. 17, 2013 in the Korean Intellectual Property Office and assigned Serial No.10-2013-0042161, the entire disclosure of which is hereby incorporated by reference.

### TECHNICAL FIELD

The present disclosure relates to a function of a portable terminal, and more particularly, to a method and an apparatus for controlling a transparency of a portable terminal having a transparent display unit which supports control of the transparency of the display unit.

### BACKGROUND

Due to remarkable advances in information communication technology and semiconductor technology, the use of portable terminals has rapidly spread. In particular, portable terminals have reached a state of mobile convergence, embracing functionality and technology beyond traditional specializations.

Portable terminals include devices such as personal digital assistants (PDA), navigation assistants, notebooks, or mobile phones. A display apparatus used for such portable terminal includes a liquid crystal display (LCD), an organic light emitting diode (OLED), and the like.

Transparent display apparatuses are now in development, including devices such as a transparent organic light emitting diode (TOLED), a projection display, a transparent thin film electro luminescence (TFEL), a transparent liquid crystal display (LCD), and a transmissive display. Transparent display apparatuses may be used for large-screen displays head up displays (HUD), head mount displays (HMD), show windows, and refrigerators, etc., as well as portable terminals.

Application content that is displayed on a front and a rear panel of a display may be more easily viewable to surrounding people, because the front, rear and side faces of a transparent display is transparent. Thus, data may be displayed easily to surrounding people through, for example, the rear face of a portable terminal. This is beneficial in environments with many surrounding persons, such as a subway car, or a commuter bus.

### SUMMARY

Accordingly, the present disclosure may provide a method and an apparatus for controlling a transparency of a transparent display unit that supports the display of information on at least part of the transparent display unit area according to at least one of application information or situation information.

In accordance with an aspect of the present disclosure, a method for controlling a transparency of a portable terminal having a transparent display unit includes: receiving an event information to execute an application, determining a display mode of the application based on the received event information, and adjusting a transparency of the transparent display unit according to the determined display mode.

In another aspect of the present disclosure, an apparatus for controlling a transparency of a portable terminal is disclosed, including a transparent display unit configured to display an application and a controller configured to: receive an event information to execute the application, determine a display mode of the application based on the received event information, and control the transparent display unit to adjust a transparency of the transparent display unit according to the determined display mode.

### BRIEF DESCRIPTION OF THE DRAWINGS

The present disclosure will be more apparent from the following detailed description in conjunction with the accompanying drawings, in which:

FIG. 1 is a block diagram of a portable terminal according to an example embodiment of the present disclosure;

FIG. 2 is a flowchart illustrating an example method for controlling a transparency according to an embodiment of the present disclosure;

FIG. 3 is a flowchart illustrating an example method for controlling a transparency according to another embodiment of the present disclosure;

FIG. 4A, FIG. 4B, FIG. 4C and FIG. 4D are diagrams illustrating an example method for controlling a transparency according to an embodiment of the present disclosure; and

FIG. 5A, FIG. 5B and FIG. 5C are diagrams illustrating an example method for controlling a transparency according to another embodiment of the present disclosure.

### DETAILED DESCRIPTION

A method and electronic device for controlling a transparency in a portable terminal will be described in more detail. Application content that is displayed on a front and a rear panel of a display may be more easily viewable to surrounding people, because the front, rear and side faces of a transparent display is transparent. Thus, data may be displayed easily to surrounding people through, for example, the rear face of a portable terminal. This is problematic if the user is viewing sensitive information in environments with many surrounding persons, such as a subway car, or a commuter bus.

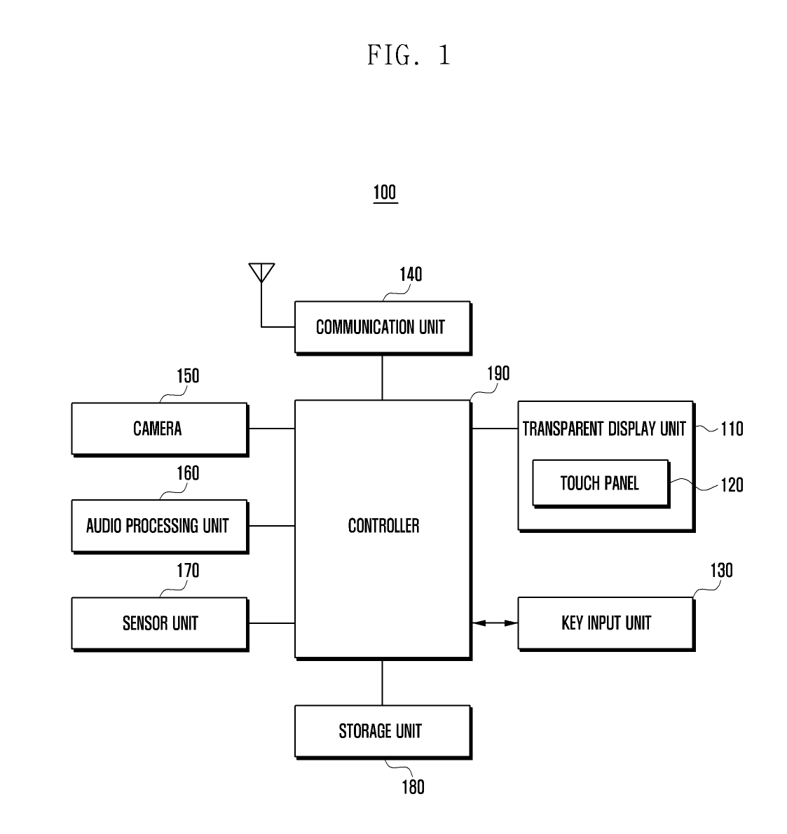

FIG. 1 is a block diagram of a portable terminal according to an example embodiment of the present disclosure.

Referring to FIG. 1, the portable terminal 100 may include a transparency display unit 110, a touch panel 120, a key input unit 130, a communication unit 140, a camera 150, an audio processing unit 160, a speaker (not shown), a microphone (not shown), a sensor unit 170, a storage unit 180, and a controller 190.

The transparent display unit 110 may show various display screens during execution of an application. The transparency of the transparent display unit 110 may be adjusted according to the application (executing via the controller 190), or the according to “situation information” received from at least one of the communication unit 140, the camera 150, the MIC, or the sensor unit 170. “Situation information,” as used herein, refers to information received from at least one of a number of information input sources for the portable terminal, including, for example, the communication unit 140, the camera 150, the microphone (now shown), or various sensors (such as sensor unit 170). The input may be used to verify whether a security condition corresponding to the executed application is required.

When the security condition is verified by the controller, the transparent display unit 110 may display a low-transparency screen or a black status for an entire screen, or a keypad and a password input box on a portion of the transparent display unit 110. In addition, when the transparency is set to be low, the transparent display unit 110 may display text, an image or a video that may include words and numbers on the screen.

The transparent display unit 110 may be implemented using, for example, a hybrid transparent display unit, including a TFT-LCD, or a transparent OLED in order to better control the transparency of the screen, or to better enable the black display screen. Specifically, the transparent display unit 110 may include both a cathode and an anode of the OLED as the transparent electrode, and may display information both in front and rear sides of the transparent display unit 110 when an area occupied by a driving thin film transistor is narrowed within a pixel, the pixel configured with the driving thin film transistor and the OLED. In addition, the transparent display unit 110 may dispose two TFT-LCDs on both sides of the transparent OLED, and may adjust the transparency by controlling the amount of emitting light and an amount of OLED light that is transmitted using the two TFT-LCDs and the transparent OLED. The black display status may be implemented on a single side or both sides of the transparent display unit by completely blocking transmitted external light and a reflected light (itself generated by a reflection of the external light). Here, the low-transparency screen or the black status screen may be the screen that is difficult to observe from the rear side. The transparent display unit 110 may include a plurality of image layers that display the images, and may support the lowest layer to be configured with an opaque or a black status image layer. In addition, the transparent display unit 110 may output the image layer according to the application execution on the highest layer. Through such configuration of transparent display unit 110, the portable terminal of the present disclosure may support the image layer of the front side, and prevent observation of the displayed imagery from the rear side of the transparent display unit.

The touch panel 120 may generate a touch event in response to a contact of a user finger, or the like, and may deliver the generated touch event to the controller 190. The touch panel 120 may deliver the coordinates included in a touched area, such as the area touched by a user finger or a pen, etc. to the controller 190, and the controller 190 may determine at least one of the coordinates included in the touch area as a set of touch coordinates. The user may perform multiple actions through touch, such as executing a desired application by contacting a finger to the touch panel 120, and inputting a password via selection of a text, such as a letter and a number, according to the executed application. With respect to a transparent display unit 110, the touch panel 120 may be implemented so as to enable detection of a touch event in response to the contact of a user finger to either side or both sides of the respective screen.

The key input unit 130 may include a plurality of keys to receive the number or the letter information, and to set various functions. Such keys may include a menu or home key, a screen on/off key, a power on/off key and a volume control key, etc. The key input unit 130 may generate a key event related to the user setting or function control of the portable terminal 100, and may deliver the key event to the controller 190.

A physical key input unit 130 may be referred to as a “hard” key, and a virtual key displayed on the transparent display unit 110 may be referred to as a “soft” key. When the key input unit 130 is implemented as the virtual keypad on the transparent display unit 110 according to an embodiment of the present disclosure, the controller 190 may, for example, implement transparency of a screen area corresponding to the virtual keypad, or implement opacity of the transparent display unit 110, setting the screen to display the black display status, protecting, for example, the security of entered information.

The communication unit 140 may support a communication function. The communication unit 140 may, for example, form a communication channel with a base station in order to support communication with external devices, and may receive information from external sources according to user control, configuration or pre-set schedule information, or may support to transmit information stored in the portable terminal 100 or information collected by the portable terminal 100 to the external. In addition, the communication unit 140 is may support communication sub-modules with short distance communication function such as Bluetooth, Wireless Local Area Network (WLAN), or Near Field Communication (NFC). The communication unit 140 form a short distance communication channel with, for example, another portable terminal 100, and transmit data, such as stored images. The communication module 140 may be omitted when the portable terminal 100 does not require a communication function.

The communication unit 140 may support other communication functions, such as transmitting/receiving text messages, instant message, video calls and on-line banking, etc. Information received through the communication unit may be displayed on the transparent display unit 110 under the control of the controller 190. For example, when the user inputs the text message, the controller 190 may control the display unit 110 to display the text message on the transparent display unit 110, and may transmit the text message to another terminal. In addition, when the controller 190 receives the text message from another terminal through the communication unit 140, the controller may control the transparent display unit 110 to display the received text message on the transparent display unit 110.

Further, the communication unit 140 may serve as a sensor for detecting situation information. For example, when the user moves to a new location, the portable terminal 100 may receive a Wi-Fi signal accessible from the new location through the communication unit 140. The controller 190 may determine that the current portable electronic device 100 requires some added security through the received Wi-Fi signal.

The audio processing unit 160 may include a speaker (not shown) to output audio data in response to a transparency setting of the transparent display unit 110, a request to play a stored audio file, and a request to play audio data received from an external source. In addition, the audio processing unit 160 may support audio data collecting, and to this end, the audio processing unit 160 may include the microphone (not shown). The audio processing unit 160 may record audio data of other people input from the surrounding environment of the portable terminal 100, and audio data generated by, for example a vehicle. The data may be transmitted to the controller 190. The controller 190 may verify whether security for the portable terminal 100 is required based on the received voice data by identifying the contextual situation based on the received data. In addition, when it is verified that the security is required, the controller 190 may output a corresponding guide sound through the audio processing unit 160. For example, a guide sound may state to the user that the portable terminal 100 is “altering the transparency of the transparent display unit 110 according to the security situation”. Such audio data collection and output function may be omitted according to user configuration or manufacturer intent at the time of configuring the portable terminal 100.

The camera 150 may deliver image data of a captured. The camera 150 may also serve as a sensor to verify whether the security is required based on the image or video data collected by the camera 150. For example, when the user moves into some public setting, the camera 150 may capture visual information indicating the surrounding context, such as pictures of neighboring people or objects. The data may then be delivered to the controller 190. The controller 190 may verify whether security is required by, for example, determining whether the number of people in the captured data exceeds a preset certain number, or whether the portable terminal 100 is moving faster than a preset speed. Based on the analysis, the controller 190 may determine whether security is required. For example, the controller 190 may determine that the user is using public transportation, such as a bus, or a subway. When the user is in a public transportation context, the controller 190 may determine that a security is required, because information is easily exposed through the rear side of the transparent display unit 110. Accordingly, the portable terminal 100 may decrease the transparency of the transparent display unit 110 on one side of the transparent display unit 110, thereby preventing other persons from viewing displayed information. On the other hand, when the user is operating a private vehicle, the controller 190 may determine that the situation does not require a security, and may display the executed application information by increasing the transparency of the display unit.

The sensor unit 170 may detect a physical quantity (e.g., an amount of ambient light, a speed, a rate of acceleration, an altitude, or an amount of gravity, etc.) or a variation in a physical quantity, and may transmit information on the detected quantity to the controller 190. The sensor unit 170 may thus include, for example, an acceleration sensor, a pressure sensor, an infrared sensor, a gyroscope, or a terrestrial magnetism sensor, etc. The sensor unit 170 may collect various information regarding the environment in which the portable terminal 100 is situated. For example, when the user enters an office, the pressure sensor may detect the present pressure and the fact that a change in pressure has occurred in the office. An infrared sensor may allow the portable terminal 100 to detect a surrounding temperature. Based on the information received from the sensor unit 170, the controller 190 may determine whether security is required, and may control the transparency of the transparent display unit 110 to be adjusted in response. In addition, in order to verify more precisely whether security is required, the controller 190 may combine with data received from at least one of the sensors to analyze information.

The sensor unit 170 may verify the location and time of the portable terminal 100 by utilizing a Global Positioning System “GPS” module (not shown). That is, the controller 190 may verify the current location and time of the portable terminal 100 based on GPS information received from the GPS module and/or the sensor unit 170. The controller 190 may verify whether the security is required based on the current location and time information.

The sensors included in the sensor unit 170 may be integrated in a single chip, or may be implemented with separate chips, and may continue to detect situation information in a certain time interval, even though the portable terminal 100 is turned-on, or even if the application is executed in the portable terminal 100.

The storage unit 180 is a memory unit of the controller 190, and may include a disc, a RAM, and a flash memory. In particular, the storage unit 180 may store various applications. For example, the storage unit 180 may store the applications such as a Web browser, an email program, an instant messenger, and a smartphone banking, etc., and any other application that is, for example, received from an app market and installed to the portable terminal 100. In addition, the storage unit 180 may store data generated from the camera 150 or sensor unit 170 of the portable terminal 100, or data received from an external device connected through the communication unit 140 or an external device interface (not shown). External devices may include, for example, a server, a desktop PC, and a tablet PC, etc. The controller 190 may receive the event information for the application execution through the key input unit 130, the communication unit 140, the camera 150, the audio processing unit 160, or the sensor unit 170. The event information may include information on applications that are not terminated during the previous execution, and the application information reserved by the user designation. For example, the reserved application information may be an information associated with an application which will be executed on scheduled time that user designates. That is, even though the controller 190 receives non-terminated applications or reserved application execution event information, the controller 190 may verify whether the non-terminated application or the reserved application is an application that requires a security.

The storage unit 180 may store, for example, an application type and a configuration setting indicating that the application type requires a security. The information may be stored in, for example, a table format, the exact configuration of which may be determined by user setting or designer intent. The information may be stored in, for example, the storage unit 180. The controller 190 may verify whether a security is required by comparing the executed application with the application table stored in the storage unit 180. When the controller 190 receives situation information from sources such as the communication unit 140, the camera 150, the microphone, and/or the sensor unit 170, it may then verify whether a security should be applied by comparing the provided situation information data with any presets or configurations indicating a security is required. After that, when it is verified that a security is required, the controller 190 may adjust the transparency of the transparent display unit 110 to provide increased security. In particular, the controller 190 may raise the transparency of the transparent display unit 110 from, for example, 100% to 0% according to the executed application or the situation information, where a 0% transparency refers to the opaque black display status, and 100% refers to a completely transparent or the maximum transparency that the transparent display unit may have.

In addition, the storage unit may store not only an operating system (OS) for operating the portable terminal 100, but also the application program for other optional functions, such as a playing music, displaying an image or a video, and displaying or streaming television programming. In particular, the storage unit 180 may include a transparency controlling program for the transparent display unit 110. The transparency controlling program may include a configurable routine controlling the transparency of the transparent display unit 110, allowing selection of an area in which the transparency is controlled, or adjusting the transparency corresponding to displayed text including, for example, a letter, number, specific image or video.

The controller 190 may control an overall operation of the portable terminal 100, coordinate signal flow between the internal configurations of the portable terminal 100, and perform a data processing function. In addition, the controller 190 may control a power supply from a battery to internal components. Further, the controller 190 may execute various stored applications. In particular, the controller 190 may verify whether a security is required by receiving the event information related to an executing application, and/or the situation information from the communication unit 140, the camera 150, the audio processing unit 160, or the sensor unit 170. In response, the controller may adjust the transparency of the transparent display unit 110 when it is verified as a security context. The controller 190 may display the information on a single side or both sides of the transparent display unit 110, and may cause the entire rear side area of the screen to display an opaque black status display screen when the transparent display unit 110 is controlled to display the information on both its faces. On the other hand, when the transparent display unit 110 is controlled to display information on only a single side, the controller 190 may adjust the transparency of the front side area where the user may view the display information. That is, the controller 190 may control lower layers (for example, layers executed on background) among a plurality of image layers of the transparent display unit 110 to be configured as the opaque or the black status image layer, and on the contrary to this, for the highest layer (for example, fore-ground layer), the controller 190 may control the image layer to be displayed in the lower transparency status according to the executed application. For some screen areas in the transparent display unit 110, such as a keypad and a password input box, the controller 190 may display a background screen or the black status background screen with a low transparency. In particular, the controller 190 may control the transparency corresponding to the text (including the letter or the numbers, etc., the specific image and the video input, etc.) received from the key input unit 130 or the touch panel 120, and display them on the transparent display unit 110.

In addition, the controller 190 may further include a timer (not shown), and may generate a necessary time data under the control of the controller 190, and may use the generated time data for a count operation of a certain period of time. By using the timer, the controller may verify whether the security is required by analyzing the situation information received for the certain time interval from the communication unit 140, the camera 150, the audio processing unit 160, and the sensor unit 170.

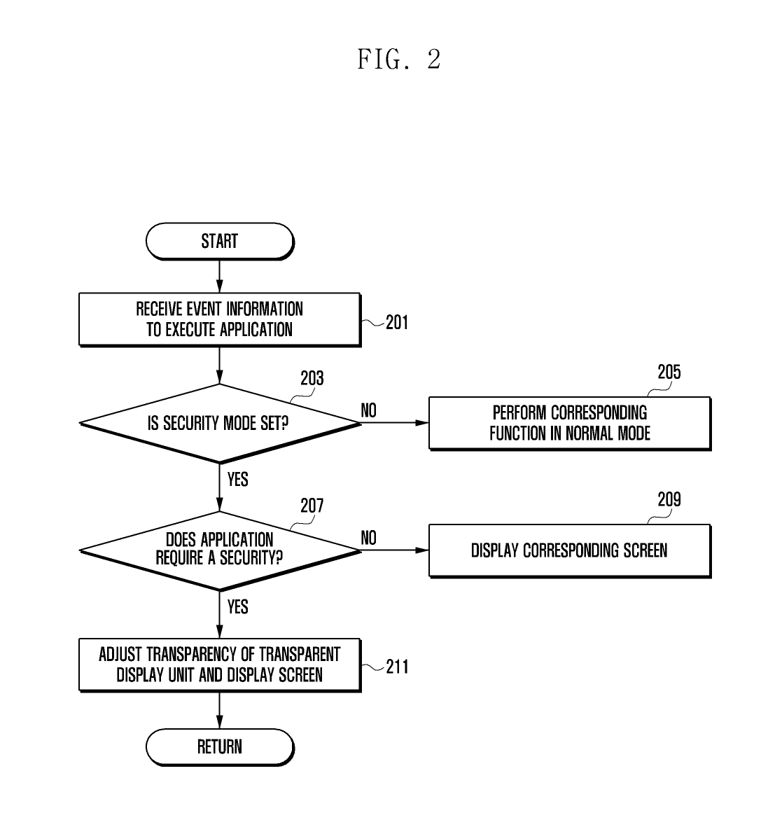

FIG. 2 is a flowchart illustrating a method for controlling a transparency according to an embodiment of the present disclosure.

Referring to FIG. 2, at operation 201, the controller 190 may receive the event information to execute the application from the touch panel 120, the key input unit 130, or the communication unit 140, etc. Here, the event information may include the information received from the communication unit 140 as well as information input by the user's contact to the touch panel 120. In particular, the controller 190 may control the application to be executed by receiving the touch event information corresponding to an application icon display on the screen of the transparent display unit 110 or the key event through the key input. In addition, the controller 190 may receive the event information executing the applications such as the receipts of a video call, a text message, an instant message, etc. through the communication unit 140. Further, the controller 190 may execute the application by acknowledging a movement of the portable terminal 100 or the user gesture by the sensed event information received from the sensor unit 170 that includes various sensors such as an acceleration sensor, a gyroscope, a gyro sensor, an infrared sensor, and an ultrasonic sensor, etc. In addition, the event information may include non-terminated application information and/or the information from an application which is reserved to execute by designating a certain period of time.

For example, when information for an executing application requires more security, the transparency is set to a more opaque level. Similarly, the rear side of the transparency display unit 110 may display an opaque black status screen when the phone is receiving or performing a telephone call, or when the portable terminal 100 is converted into the lock status and the executed application is not terminated properly. In these situations, when the user terminates the call, or unlocks the phone, the non-terminated application may resume execution without any determination of whether to apply a security function, possibly allowing sensitive information to be exposed. Therefore, the portable terminal 100 of the present disclosure may include “non-terminated application” information in the event information delivered to the controller 190 in order to verify whether to apply security function to the non-terminated application. Similarly, when an application is set to execute at a predetermined time, the controller 190 may verify whether to apply the security function corresponding to the scheduled application. However, the reception setting of the non-terminated application information or the reserved application information may be omitted according to user preference or the designer intent.

In operation 203, the controller 190 may determine whether a security mode is set between the security mode and normal mode. The application display mode may be divided into, for example, a normal mode and a security mode. In a normal mode, the transparency controlling function is not applied. In a security mode, the transparency controlling function is applied according to at least one of the application type or the situation information change. According to one embodiment of the present disclosure, the controller 190 may display a message to select the display mode based on the received event information. The message may be displayed in a separate pop-up window, as a menu list or as an icon. When the user selects the security mode, the controller 190 may execute the transparency controlling function of the transparent display unit 110. As described above, depending on the user selection of the display mode, the execution of the transparency controlling function may be prevented, regardless of the user intention. When the display mode of the application is set as the normal mode at operation 203, the transparency controlling function is not applied, and a corresponding function may be executed, according to the received event information, at operation 205. At operation 203, after determining whether a security mode should be applied, the controller 190 may verify whether the executing application requires a security based on the event information at operation 207. In particular, the controller 190 may verify whether a security is required according to the executed application types. For example, when the text message and the instant message are transmitted and received, the controller 190 may verify that the text messenger and instant messenger applications are require a security. Similarly, smartphone applications such as on-line banking, memo function, a contacts program, and a calendar/scheduling application may require a security as well.

Information regarding application types pre-specified to require a security may be stored in the storage unit 180 in, for example, a table format. The user may pre-set applications as requiring a security, or such applications may be designated by the designer. The table may be used by the controller 190 to verify whether a security is required by receiving information regarding an executing application, and comparing the application information with the application table.

At operation 207, when it is verified that the executed application does not require security, the controller 190 may control to display the corresponding application execution screen on the transparent display unit 110 without controlling the transparency at operation 209.

At operation 207, when the executed application is determined to require a security, the controller 190 may adjust the transparency of the transparent display unit 110 of the portable terminal 190 at operation 211 such that it is more difficult for observers to observe the information displayed on the transparent display unit 110. The controller 190 may display the information on a single side or both sides of the transparent display unit 110, and when the transparent display unit 110 displays the information on both sides, it may cause the entire rear side of the transparent display unit to display an opaque black status screen. The transparent display unit 110 of the present disclosure may be implemented with a hybrid transparent display unit (not shown) including a TFT-LCD (not shown) and a transparent OLED (not shown). In particular, two TFT-LCDs are disposed on both sides of a transparent OLED, and the transparent OLED is turned on and controlled to emit a light. At this time, when the external light is blocked by turning-off the TFT-LCD corresponding to the rear side of two TFT-LCDs, a screen corresponding to the turned-off TFT-LCD may be maintained as the opaque black status screen.

On the other hand, when the transparent display unit 110 is controlled to display the information on the single side, the controller 190 may control to adjust the transparency of the entire front side area of the screen where the user may view the displayed information. For example, the controller 190 may control the lowest layer of a plurality of image layers of the transparent display unit 110 to be configure with the opaque or the black status image layer, and, for the highest layer, the controller 190 may control the image layer according to the application execution to be configured with the layer having a low transparency.

In addition, the controller 190 may display some areas of the screen in the transparent display unit 110 such as the keypad and the password input box as the low-transparency screen or the black status. In particular, the controller 190 may adjust the transparency corresponding to the text including the letter and the number, the specific image and the video received from the key input unit 130 or the touch panel 120 to be displayed on the screen of the transparent display unit 110.

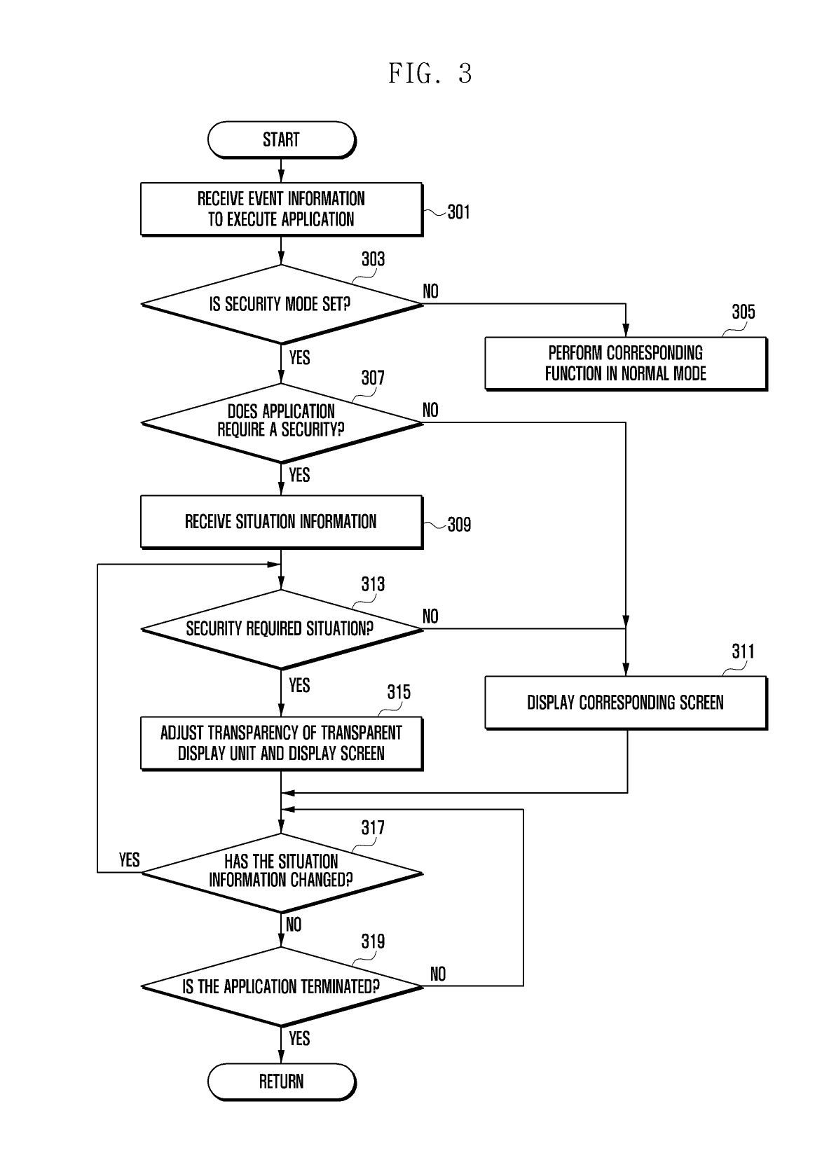

FIG. 3 is a flowchart illustrating an example method for controlling a transparency according to another embodiment of the present disclosure.

Referring to FIG. 3, the description from operation 301 to operation 307 corresponds to the operations 201 to 207 of FIG. 2. Accordingly, they will be omitted for the sake of brevity.

At operation 307, when the executing application is verified as an application requiring a security, the controller 190 may receive the situation information from the communication unit 140, the camera 150, or the sensor unit 170 at operation 309. Specifically, the controller 190 may receive a short distance communication channel setting request signal, and a Wi-Fi setting signal, such as a Bluetooth signal, a Wireless Local Area Network (WLAN) signal, or a Near Field Communication (NFC). Communicatively coupling may thus be implemented with another terminal through the communication unit 140 of the portable terminal 100. In addition, the controller 190 may receive a text message, instant message, or video call with another terminal, or transmit and receive information for applications such as smartphone-enabled online banking through the communication unit 140. In addition, the controller 190 may receive information corresponding to a movement situation, a current location, and a number of neighboring people based on the image data or the video data collected through the camera 150.

The controller 190 may receive the situation information from the sensor unit 170. The sensor unit 170 of the portable terminal 100 may include an acceleration sensor, an infrared sensor, a gyroscope, a terrestrial magnetism sensor, and a pressure sensor, and the controller 190 may receive situation information from the at least one of the sensors listed above.

On the other hand, when the application executed by the controller 190 is verified as not requiring a security at operation 307, the corresponding application execution screen may be displayed on the transparent display unit 110 without transparency control at operation 311.

At operation 313, the controller 190 may verify whether a security is required, according to the situation information received at operation 309. Specifically, the controller 190 may receive situation information from the communication unit 140, the camera 150, or the sensor unit 170, and may verify whether a security is required by comparing the received situation information with the pre-defined situation information data.

When it is determined by the controller 190 that the current situation does not require a security at operation 313 (such as, for example, when there are no other people around the portable terminal 100), the controller 190 may control the corresponding application execution screen to be displayed on the transparent display unit 110 without transparency control, at operation 311.

On the other hand, when it is determined by the controller 190 that the current situation requires a security at operation 313, the controller 190 may adjust the transparency of the transparent display unit 110 of the portable terminal at operation 315.

When displaying the transparency-adjusted screen (from operation 315), the controller 190 may verify whether the situation information has changed since a, for example, predetermined time interval has elapsed, at operation 317. Here, the changed situation information may include the case where the information which is initially or previously received from the communication unit 140, the camera 150, and the sensor unit 170 of the portable terminal 100 has changed. As described above, the portable terminal 100 may perform a monitoring function to detect when situation information changes.

When the portable terminal 100 detects that the situation information has changed at operation 317, it may return to operation 313. When it is verified that the situation information has not changed, the transparency of the transparent display unit 110 screen may maintain the transparency-adjusted state, and may verify whether the executed application is terminated at operation 319. When the executed application is not terminated at operation 319, it may return to operation 317. When the executed application is terminated, it may return to operation 301.

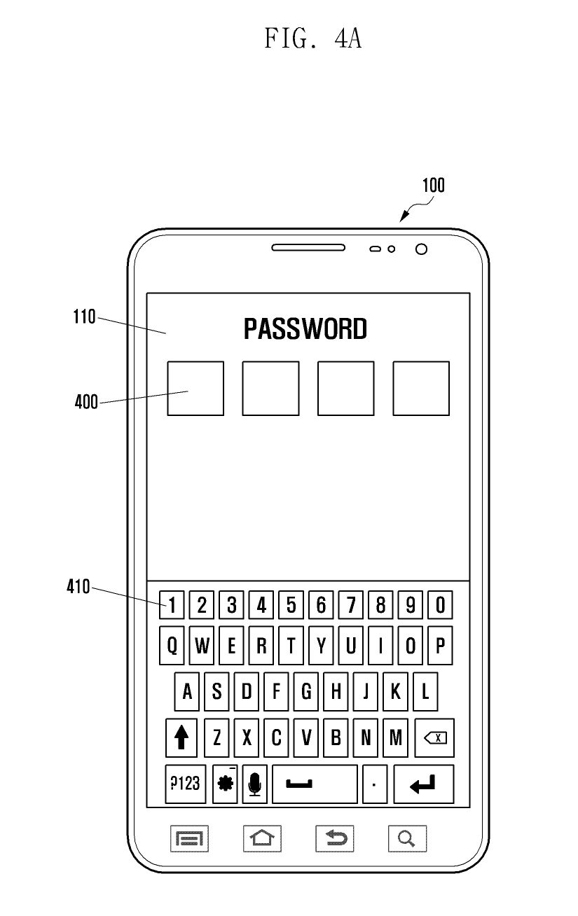

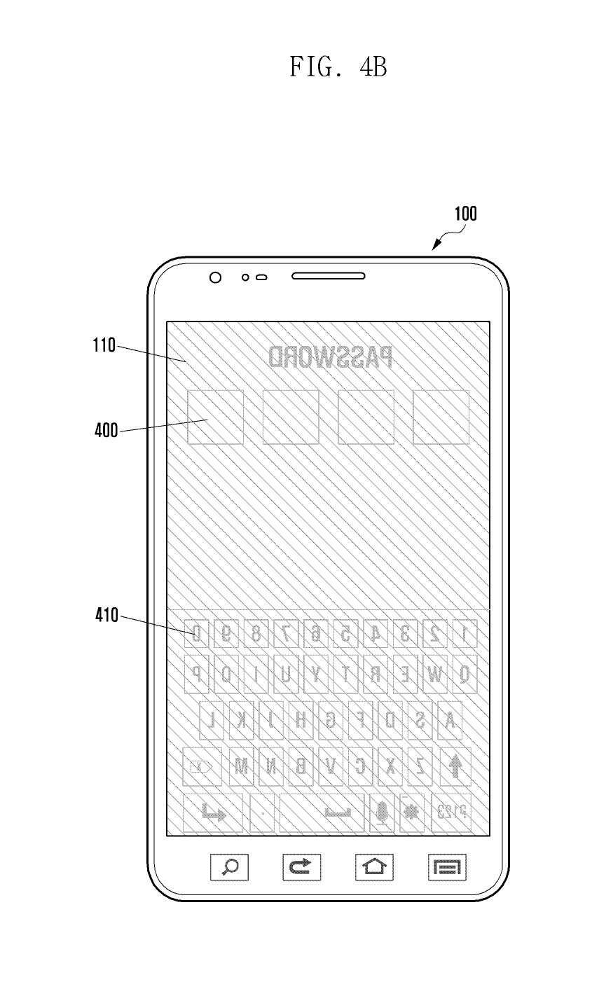

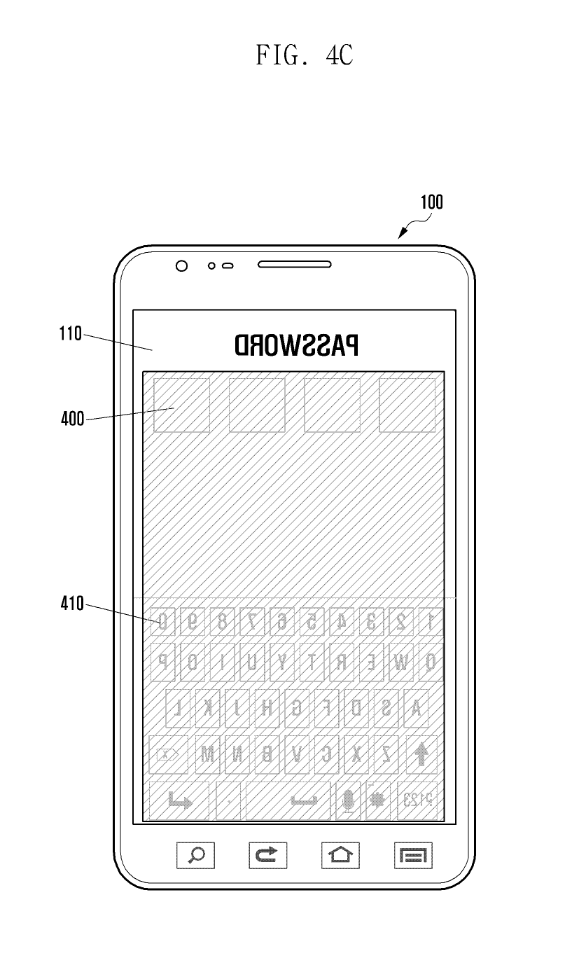

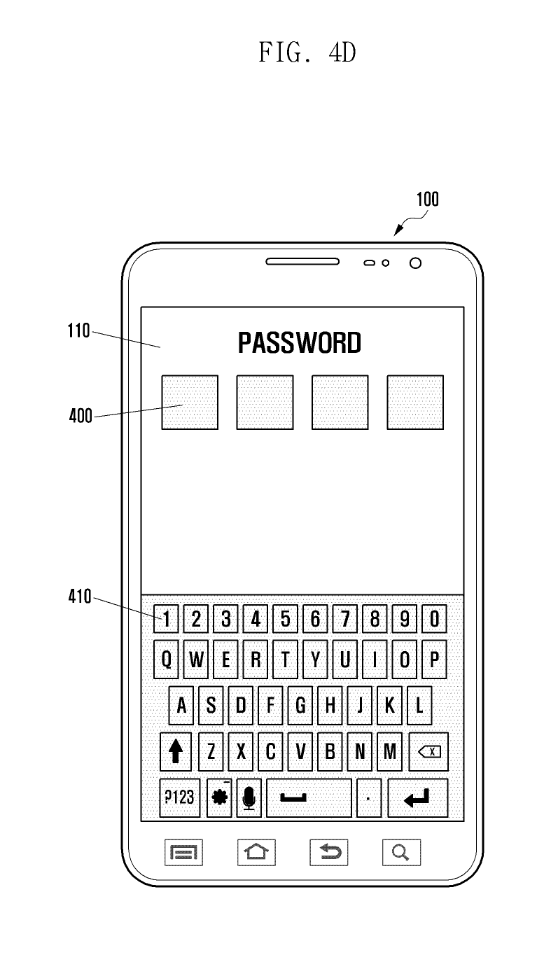

FIG. 4 is a diagram illustrating an example method for controlling a transparency according to an embodiment of the present disclosure.

Referring to FIGS. 4A to 4D, FIG. 4A illustrates a screen of normal mode where the password input box 400 and a virtual keypad 410 are displayed on the front of the transparent display unit 110 of the portable terminal 100. FIGS. 4B to 4D illustrate a screen where the transparency of the transparent display unit 110 of the portable terminal 100 is adjusted. Specifically, FIG. 4B applies the transparency-adjusted black status display screen across the entire screen area, including the password input box 400 and the virtual keypad 410 on the rear side of the transparent display unit 110. In FIG. 4C, the black status display screen is utilized everywhere except for some parts of the rear side of the transparent display unit 110, that is, for example, everywhere except for the area where a ‘PASSWORD’ text is displayed (being left-right reversed), the area of the password input box 400, and the virtual keypad 410. Meanwhile, when the transparent display unit 110 of the portable terminal 100 is set to display only on a single side, the transparency of the transparent display unit 110 may be adjusted and displayed only in select areas of the front side of the transparent display unit 110, as shown in FIG. 4D. At this time, the background screen of the transparent display unit 110 may maintain the transparent status, and the transparency may be adjusted down to a more opaque level for the password input box 400 and the virtual keypad 410. Simultaneously, although not shown, the front side of the transparent display unit 110, including the background screen, the password input box 400 and the virtual keypad 410 may be displayed in a transparency-adjusted more opaque state. As described above, when displaying information on both sides of the transparent display unit 110 of the portable terminal 100, the entire area or a partial areas of the rear side of the transparent display unit 110 may displayed the black status display, and the transparency may be adjusted to a more opaque level when displaying information on a single side of the transparent display unit 110.

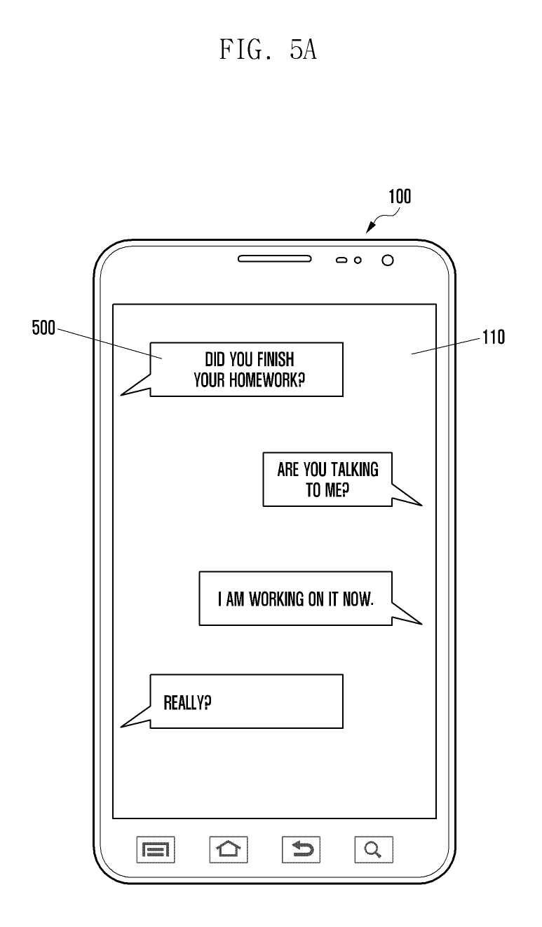

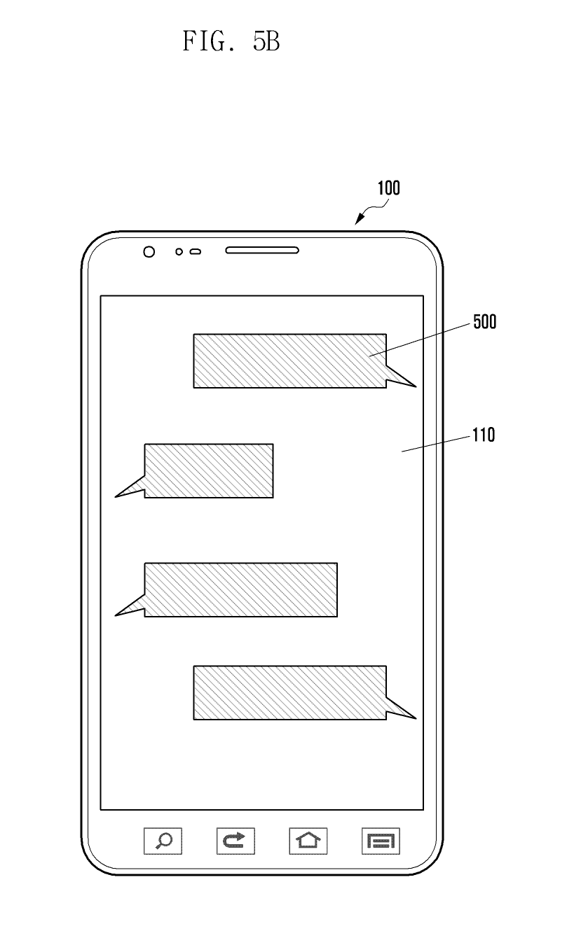

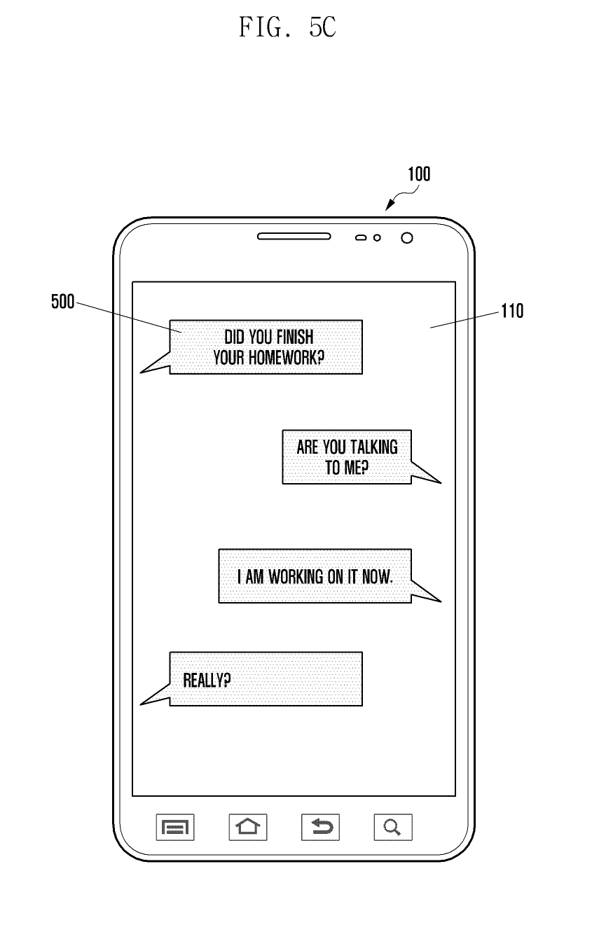

FIG. 5 is a diagram illustrating an example method for controlling a transparency according to another embodiment of the present disclosure.

Referring to FIGS. 5A to 5C, FIG. 5A illustrates a screen where information is displayed on the front side of the transparent display unit 110 of the portable terminal 100. That is, in FIG. 5A, when the text message or the instant message application is executed, the text including the letter, numbers, etc. may be displayed on a front side of the transparent display unit 110. On the other hand, in FIG. 5B, the text part 500 may be displayed on a rear side of the same portable terminal 100 using the black status display screen, preventing others from viewing the content of the messages. Alternatively, as depicted in FIG. 5C, when the transparent display unit 110 screen of the portable terminal 100 is configured to display only on a single side, the transparency may be adjusted in the text message portion 500, and only for the front side of the transparent display unit 110.

The controller may adjust the transparency of the transparent display unit 110 with respect to a specific input, such as, for example, a text input reception, or a text input reception from another terminal through the communication unit 140. That is, when the text input is transmitted/received, the text part 500 of the rear side of the transparent display unit 110 may be displayed as the black status display screen, as illustrated in FIG. 5B. In addition, when the transparent display unit 110 is set to display information on the single side of screen, the transparency of the text part 500 may be adjusted and displayed as illustrated in FIG. 5C. Further, when a voice data is input from the microphone and converted into a text by a speech-to-text “STT” program, and displayed on the transparent display unit 110, the security function according to the present disclosure may be applied. In addition, although not shown, when video data of another party in a video call is input, the transparency corresponding to the area where the video is displayed may be adjusted as well.

As described above, a method for controlling a transparency of the transparent display unit of the present disclosure may include adjusting the transparency of the transparent display unit 110 according to at least one of the application or the situation information.

As described above, according to a method and an apparatus for controlling a transparency in a portable terminal having a transparent display unit, the present disclosure may provide more comfortable security function through adaptive transparency control. Hence, a user may execute an application confidant that private information will remain secure, even in an environment where the information may be easily exposed.

Embodiments of the present disclosure are described with reference to the accompanying drawings in detail. The same reference numbers may be used throughout the drawings to refer to the same or like parts. Detailed descriptions of well-known functions and structures incorporated herein may be omitted to avoid obscuring the subject matter of the present disclosure.

Prior to the detailed description of the present disclosure, the terms or words using herein should not be limited to be construed as a general or a dictionary meanings, and should be interpreted as a meanings or concepts corresponding to a technology ideas of the present disclosure. Therefore, since the following description and accompanying drawings are nothing but an embodiment of the present disclosure, and not representative to all technology ideas of the present disclosure, it should be understood that various equivalents and modifications that may replace thereof may exist at the point of this application. In addition, some components in the accompanying drawings are illustrated as exaggerated, omitted, or schematically, and a size of each component does not utterly reflects an actual size. Accordingly, the present disclosure is not limited by a relative size or an interval drawn in the accompanying drawing.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although embodiments of the present disclosure have been described in detail hereinabove, it should be clearly understood that many variations and modifications of the basic inventive concepts herein taught which may appear to those skilled in the present art will still fall within the ambit of the present disclosure, as defined in the appended claims.

What is claimed is:

1. A method for controlling a transparency in a portable terminal having a transparent display unit, the method comprising:
receiving an event information to execute an application;
determining a display mode of the application based on the received event information; and
adjusting a transparency of the transparent display unit according to the determined display mode.

2. The method of claim 1, wherein the event information includes at least one of touch event information received from a touch panel, key event information received from a key input unit, sensing event information received from a sensor unit, and non-terminated application information and scheduled application.

3. The method of claim 1, further comprising:
identifying whether the application requires a security when the display mode is determined as a security mode;
wherein adjusting the transparency of the transparent display unit according to the determined display mode comprises adjusting the transparency of the transparent display unit according to the security mode when the application is identified as a security required application.

4. The method of claim 1, wherein the application is at least one of a text messenger, an instant messenger , a phonebook, a memo application, an online banking application, and a video call.

5. The method of claim 1, wherein adjusting the transparency of the transparent display unit comprises adjusting the transparency of an entire or a part of the transparent display unit.

6. The method of claim 5, wherein the part of the transparent display unit includes at least one of a password input field and a virtual keypad area.

7. The method of claim 5, wherein adjusting the transparency of the transparent display unit comprises:
adjusting the transparency on an area corresponding to at least one of a text graphic, an image graphic and a video.

8. The method of claim 3, further comprising:
receiving situation information from at least one of a communication unit, a camera, an audio processing unit and a sensor unit, and
identifying whether the security is required according to the received situation information.

9. The method of claim 8, wherein the situation information includes at least one of a Wi-Fi signal, image data, video data, audio data, pressure data, and GPS data.

10. The method of claim 8, wherein identifying whether the security is required according to the received situation information comprises identifying whether the security is required by comparing the received situation information with pre-defined situation information.

11. The method of claim 8, further comprising:
identifying whether the situation information received in a certain time of period interval is changed.

12. An apparatus having a transparent display unit, comprising:
a transparent display unit configured to display an application; and
a controller configured to:
receive an event information to execute the application;
determine a display mode of the application based on the received event information; and
control the transparent display unit to adjust a transparency of the transparent display unit according to the determined display mode.

13. The apparatus of claim 12, wherein the event information includes at least one of touch event information received from a touch panel, key event information received from a key input unit, sensing event information received from a sensor unit, and non-terminated application information and scheduled application.

14. The apparatus of claim 12, wherein the controller is further configured to:
identify whether the application requires a security when the display mode is determined as a security mode; and
control the transparent display unit to adjust the transparency of the transparent display unit according to the security mode when the application is identified as a security required application.

15. The apparatus of claim 12, wherein the application is at least one of a text messenger, an instant messenger, a phonebook, a memo application, an online banking application, and a video call.

16. The apparatus of claim 12, wherein the controller is configured to adjust the transparency of an entire or a part of the transparent display unit.

17. The apparatus of claim 16, wherein the part of the transparent display unit includes at least one of a password input field and a virtual keypad area.

18. The apparatus of claim 16, wherein adjusting the transparency of the transparent display unit comprises:
adjusting the transparency on an area corresponding to at least one of a text graphic, an image graphic and a video.

19. The apparatus of claim 14, the controller further configured to:
receive situation information from at least one of a communication unit, a camera, an audio processing unit and a sensor unit; and
identify whether the security is required according to the received situation information.

20. The apparatus of claim 19, wherein the situation information includes at least one of a Wi-Fi signal, image data, video data, audio data, pressure data, and GPS data.

21. The apparatus of claim 19, wherein the controller is configured to identify whether the security is required by comparing the received situation information with pre-defined situation information.

22. The apparatus of claim 19, the controller further configured to identify whether the situation information received in a certain time of period interval is changed.
